(19) United States
(12) Patent Application Publication
(10) Pub. No.: US 2014/0050449 A1
(43) Pub. Date: Feb. 20, 2014

(54) OPTICAL FIBRE OPTIMIZED FOR THE REDUCTION OF NONLINEAR EFFECTS

(71) Applicant: Luc Thevenaz, Yverdon-les-Bains (CH)

(72) Inventor: Luc Thevenaz, Yverdon-les-Bains (CH)

(73) Assignee: ECOLE POLYTECHNIQUE FEDERALE DE LAUSANNE (EPFL), Lausanne (CH)

(21) Appl. No.: 13/989,557

(22) PCT Filed: Dec. 7, 2011
(86) PCT No.: PCT/IB11/55522

§ 371 Date: Jul. 30, 2013

(30) Foreign Application Priority Data
Dec. 7, 2010 (IB) 2010/055615

(51) Int. Cl. G02F 1/365; G02B 6/02

(52) U.S. Cl. CPC G02F 1/365; G02B 6/02214
USPC 385/122

(57) ABSTRACT

An optical fibre designed to simultaneously attenuate the effect of modulation instability and stimulated Raman scattering. A first solution proposes to use non-zero dispersion shifted fibres in the normal dispersion regime to reduce both influences at the same time. A further solution proposes to implement corresponding filter elements in the signal line. A still further solution proposes to additionally provide absorber elements for the Raman wavelengths or to design the core as a leaky one for these wavelengths.

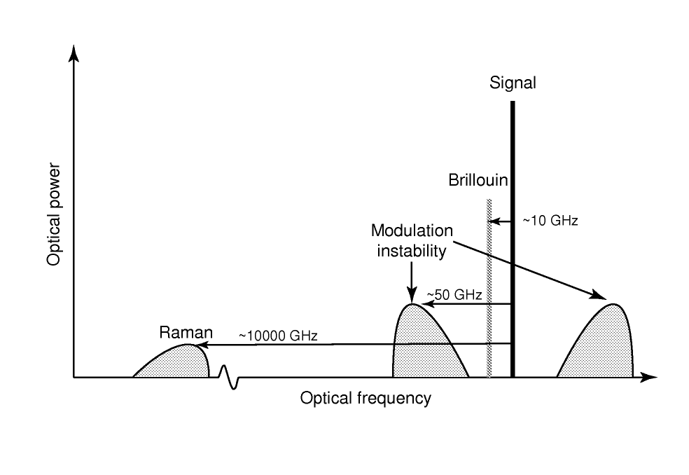

### FIELD OF INVENTION

The present invention relates to optical fibres, in particular to optical fibres propagating light over long distances, i.e. several kilometers.

### STATE OF THE ART

Optical fibres have experienced a tremendous development since 1970, in such a way that the material quality (silica) presently shows an ideal chemical purity. Optical transparency has therefore reached the ultimate limit that can be expected from the material properties. In particular the loss experienced by the light propagating in the fibre is now routinely below 0.2 dB/km, which means that half of the light is lost for every 15 km distance increment. In many situations propagation over distances of 100 km and more is desired, like for instance in telecommunication lines and in remote or distributed sensing systems. The loss penalty for a larger distance is traditionally compensated by an increased input power.

Input power cannot be increased indefinitely, since the material no longer responds in a standard way under an intense light irradiation. The optical properties of the material (glass in the case of an optical fibre) are modified and turn dependent on the light intensity. In this situation the material response is considered as nonlinear and the result is to transfer light from the signal to a distinct spectrally shifted optical wave through a gradual coupling. The signal wave is thus depleted and may entirely decay, all the light being transferred out of the spectral transmission channel. Furthermore the transfer is turning gradually more important when the amplitude of the nonlinearly generated wave is growing, through a stimulated coupling effect.

For the above reasons optical fibres of the state of the art have a relatively limited distance range.

### GENERAL DESCRIPTION OF THE INVENTION

An object of the present invention is to substantially increase the power handling capacity of the optical fibre, in particular for distributed fibre sensors, communication links or any other long range optical signal distribution systems.

To this effect the invention concerns an optical fibre as defined in the claims.

The invention concerns an optical fibre designed to substantially increase the power handling capacity over long distances. This is achieved by simultaneously increasing its immunity to the most limiting nonlinear optical effects observed in long haul sensing and transmission systems: modulation instability and stimulated Raman scattering.

This simultaneous attenuation of both nonlinear effects is obtained in taking specific actions to judiciously modify the optical properties of the fibre or the optical transmission link as a whole.

If we consider the presence of one signal wave at a definite frequency, the 3 nonlinear effects that are observed in a silica optical fibre, each corresponding to a different material response, are by decreasing importance (see the unique figure):
Stimulated Brillouin scattering: this very efficient nonlinear effect transfers light slightly shifted to a lower frequency into the backward direction only. It is a narrowband process, so it operates efficiently only on narrowband signals and its impact may be drastically reduced when wideband signals are used, like in high speed optical telecommunications. To build up efficiently it also requires a continuous light stream as a result of its backward propagation direction with respect to the signal. It is also poorly activated when isolated pulse signals are used, like in many distributed sensing configurations, since the interaction length is restricted to the pulse length in that case. To summarize, the effect of stimulated Brillouin scattering can be largely alleviated by proper modulation strategies on the signal.
Modulation instability: this effect generates two broad spectral sidebands symmetrically around the signal frequency. The nonlinearly generated waves are propagating in the same direction as the signal, so that this effect is indifferently observed for continuous data streams or isolated light pulses. The existence of modulation instability is possible only if the optical medium shows specific dispersion properties, particularly when the medium shows an anomalous group velocity dispersion (β₂<0 or D_{λ}>0). The standard strategy to eliminate modulation instability is to design the fibre to show a normal group velocity dispersion (the material dispersion is naturally anomalous where it is highly transparent at a wavelength around 1550 nm), by using a so-called “dispersion-shifted fibre”. Since the sidebands are close to the signal frequency, modulation instability is difficult to eliminate through spectral filtering.
Stimulated Raman scattering: the light is coupled out of the signal to a much more distant frequency through Raman scattering than resulting from any other nonlinear effect, into a wave that is co-propagating with the signal. Its efficiency is lower than modulation instability and its presence is not mentioned as a problem in telecommunication networks, so there is currently no specific identified strategy to reduce it. If all strategies to eliminate the other nonlinear effects are implemented, stimulated Raman scattering becomes the real limitation and it has been identified as the ultimate limit in distributed fibre sensors. Raman scattering is very difficult to eliminate, since it is a fundamental material response that does not require strict conditions to be observed (very broadband gain and very loose phase matching). The Raman wave is spectrally very distant (at a ˜100 nm longer wavelength than the signal), so that signal and Raman waves can propagate at a substantially different velocity as a result of the material dispersion. This property limits the interaction length for short isolated pulses, since after some distance the two waves will be temporally shifted and no longer overlap.

The distance range of a “state of the art” optical fibre is eventually limited by these nonlinear effects, since the signal power cannot be indefinitely increased to compensate the loss. Techniques to suppress stimulated Brillouin scattering are known, for instance in modulating the lightwave to enlarge its spectral width. There are also optical fibre designs that specifically attenuate the efficiency of stimulated Brillouin scattering. But for a wide range of applications, in particular sensing, the full efficiency of stimulated Brillouin scattering must be maintained, since it is the interaction that is exploited in the sensing process. Modulation instability and stimulated Raman scattering remain however a penalty and cannot be suppressed using the procedures applied for stimulated Brillouin scattering. For those reasons, one of the preferred embodiment of the invention consists in attenuating the effects of modulation instability and stimulated Raman scattering but maintaining Brillouin scattering. Such an approach allows to increase the range of distributed optical fibre sensors and to propagate broadband signals over longer distances in communication optical links.

A standard procedure to suppress modulation instability is to design the fibre, so that the propagation at the signal wavelength is in the regime of normal group velocity dispersion.

Raman scattering cannot be suppressed using the same procedure since it results from the material response and therefore presents specific difficulties that are solved by the present invention, proposing solutions compatible with the suppression of modulation instability. It can be for instance realized by simultaneously lowering the refractive index of the fibre core and the inner cladding, to make the refractive index of the inner cladding substantially lower than the index of the whole or a part of the outer cladding. This way the light guided in the core leaks to the outer cladding through a tunnelling effect and is lost for the guided propagation. Since the evanescent part of the guided light is larger for longer wavelength, the tunnelling effect is more pronounced when the light wavelength is increased. The fibre can be thus designed to have a negligible light leakage by this tunnelling effect at the signal wavelength and a pronounced leakage at the Raman signal wavelength that is at a ˜100 nm longer wavelength in silica fibre in the higher transparency spectral window.

Another solution is to dope the fibre with materials showing a selective higher absorption at the Raman signal wavelength, while being fully non-absorptive at the signal wavelength. For instance doping the silica at a low concentration (100 ppm and less) with rare-earth ions of Thulium realizes this selective spectral absorption for a signal propagating in the highest transparency spectral window in silica optical fibres. Other rare-earth ions can be used, such as Dysprosium and Neodymium, as well as nanoparticles and quantum dot specifically designed to realize this spectrally selective absorption.

As mentioned previously, maintaining Brillouin scattering is preferred in most of the cases but in other cases the optical fibre according to the invention may furthermore be designed to simultaneously attenuate the Brillouin scattering.

### DETAILED DESCRIPTION OF THE INVENTION

The invention will be better understood below with some non-limitative examples showing how modulation instability and Raman scattering can be attenuated.
a. The modulation instability is made impossible to build up or strongly reduced by modifying the effective dispersion undergone by the light guided in the fibre, by shaping the refractive index profile to obtain a waveguide dispersion that altogether with the material dispersion results in an effective total dispersion that makes the modulation instability impossible to build up efficiently.
b. The modulation instability is made impossible to build up or strongly reduced by modifying the effective dispersion undergone by the light guided in the fibre, by changing the fibre composition (e.g. by inclusion of nanoparticles or any aggregates of atoms, ions or molecules or doping with specific atoms, ions or molecules) to get an effective total dispersion that makes the modulation instability impossible to build up efficiently.
c. The modulation instability is made impossible to build up or strongly reduced by modifying the effective dispersion undergone by the light guided in the fibre, by placing the signal wavelength in a spectral region where the effective total dispersion makes the modulation instability impossible to build up efficiently.
d. The modulation instability is attenuated by causing an increased differential loss for the sidebands generated by modulation instability with respect to the signal, through a spectral filtering that can be either distributed along the fibre or inserted at fixed locations.
e. The signal generated by stimulated Raman scattering is attenuated by designing the guiding conditions in the optical fibre, so that the light is well guided at the signal wavelength and is in leaky or radiative mode propagation at the Raman Stokes wavelength or coupled out of the normal guiding condition at the Raman Stokes wavelength by any other means.
f. The signal generated by stimulated Raman scattering is attenuated by changing the fibre material chemical composition to create an increased absorption at the Raman Stokes wavelength.
g. The signal generated by stimulated Raman scattering is attenuated by inserting spectral filters at fixed locations along the fibre.
h. The growth of the signal generated by stimulated Raman scattering is strongly limited by reducing the interaction distance through actions taken to increase the differential group velocity between the signal and the Raman wave. These actions can be a modification of the guiding properties by modifying the refractive index profile of the fibre, by creating periodic structures in the fibre or by changing the fibre composition (e.g. by inclusion of nanoparticles or any aggregates of atoms, ions or molecules or doping with specific atoms, ions or molecules), all aiming at substantially altering the dispersive spectral response of the fibre guidance.

1. An optical fibre designed to simultaneously attenuate the effect of modulation instability and stimulated Raman scattering.

2. An optical fibre according to claim 1 which is furthermore designed to maintain Brillouin scattering.

3. An optical fibre according to claim 1 wherein the refractive index profile is shaped in a way to obtain a waveguide dispersion that altogether with the material dispersion results in an effective total dispersion that makes the modulation instability impossible to build up efficiently.

4. An optical fibre according to claim 1 wherein the fibre composition is changed in a way as to obtain an effective total dispersion that makes the modulation instability impossible to build up efficiently.

5. An optical fibre according to claim 4 wherein the fibre composition is changed by incorporation of nanoparticles, any aggregates of atoms, ions or molecules.

6. An optical fibre according to claim 1 designed in a way as to place the signal wavelength in a spectral region where the effective total dispersion makes the modulation instability impossible to build up efficiently.

7. An optical fibre according to claim 1 comprising a spectral filtering adapted to cause an increased differential loss for the sidebands generated by modulation instability with respect to the signal.

8. An optical fibre according to claim 7 wherein said spectral filtering is distributed along the fibre.

9. An optical fibre according to claim 7 wherein said spectral filtering is inserted at fixed locations along the fibre.

10. An optical fibre according to claim 1 which is designed to well guide the light at the signal wavelength and to couple it out of the normal guiding conditions at the Raman Stokes wavelength.

11. An optical fibre according to claim 10 wherein the light is in leak mode propagation at the Raman Stokes wavelength.

12. An optical fibre according to claim 10 wherein the light is in a radiative mode propagation at the Raman Stokes wavelength.

13. An optical fibre according to claim 1 wherein the fibre material chemical composition is changed in a way as to create an increased absorption at the Raman Stokes wavelength.

14. An optical fibre according to claim 1 comprising spectral filters inserted at fixed locations along the fibre in order to attenuate Raman scattering.

15. An optical fibre according to claim 1 designed in a way to increase the differential group velocity between the signal and the Raman wave.

16. An optical fibre according to claim 1 which is furthermore designed to also simultaneously attenuate the effect of Brillouin scattering.
